(19) United States
(12) Patent Application Publication
(10) Pub. No.: US 2004/0046344 A1
(43) Pub. Date: Mar. 11, 2004

(54) Big wheel snowmobile shop dolly

(76) Inventor: Edward H. Webb, Paynesville, MN (US)

Correspondence Address: KORONIS PARTS, INC., ATTN: ED WEBB, 17003 CO. RD. 181, PAYNESVILLE, MN, 56362, US

(21) Appl. No.: 10/237,289

(22) Filed: Sep. 9, 2002

(51) Int. Cl. B62B 1/00

(52) U.S. Cl. 280/47.24

(57) ABSTRACT

A large wheel on a snowmobile shop dolly for easily moving a snowmobile in a variety of conditions.

### CROSS-REFERENCE RELATED TO APPLICATION

10A Parts Unlimited 2001-02 Catalog Cover

10B Parts Unlimited 2001-02 Snowmobile Shop Dolly's

10C Parts Unlimited 2001-02 Snowmobile Shop Dolly's

11A Automatic Distributing 2001-02 Cover

11B Automatic Distributing 2001-02 Snowmobile Shop Dolly's

12A High Performance Engineering 2001-02 Cover

12B High Performance Engineering 2001-02 Snowmobile Shop Dolly's

### STATEMENT REGARDING FEDERALLY SPONSORED RESEARCH OR DEVELOPMENT

“Not Applicable”

### REFERENCE TO SEQUENCE LISTING. A TABLE, OR A COMPUTER PROGRAM LISTING COMPACT DISK APPENDIX

“Not Applicable”

### BACKGROUND OF INVENTION

This invention relates to the manufacture of a snowmobile shop dolly that rolls easily and can roll over a curb when entering a garage, dealership repair facility or other buildings. The Snowmobile industry has had snowmobile shop dollies for years but they have wheels that are too small in diameter for the surfaces they are intended to roll. In addition, all garages, repair shops and most other buildings have a small to large curb or vertical area that keep rain and snow out and increase the elevation of the building. These curbs are usually adjacent to the door opening or entry. Many times these older dollies will roll on dry surfaces but not easily and when snow is on the surface they roll poorly. They also roll poorly over curbs and generally need a powerful push by 1 or 2 people.

### BRIEF SUMMARY OF THE INVENTION

The Big Wheel Snowmobile Shop Dolly has a wheel diameter of 19 inches or larger and a width of between 1.5 inches and 3 inches. This gives this shop dolly the ability to roll easily with the weight of a snowmobile on a dry surface or when snow is present on that surface. The larger wheel also gives the ability to roll over curbs upon entering buildings. The Manufactured Shop Dolly's are references in 10A, 10B, 10C, 11A, 11B, 12A, 12B.

### BRIEF DESCRIPTION OF THE SEVERAL VIEWS OF THE DRAWING

FIG. 1: This is a front view depicting the diameter (height) and the width of the large wheel and provides a relationship to the complete dolly..

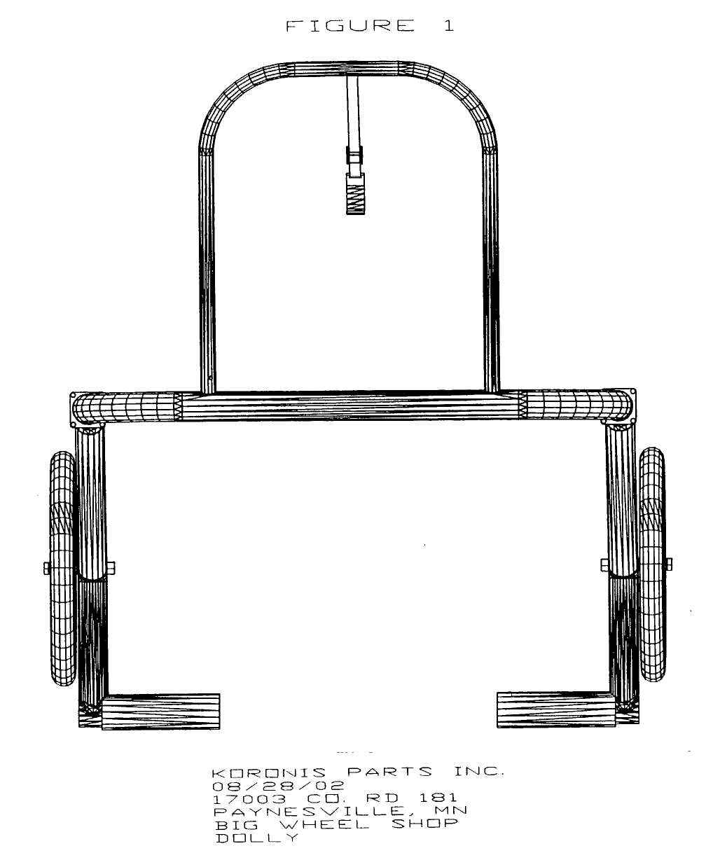

FIG. 2: This is a side view of the large wheel and provides a relationship to the complete dolly.

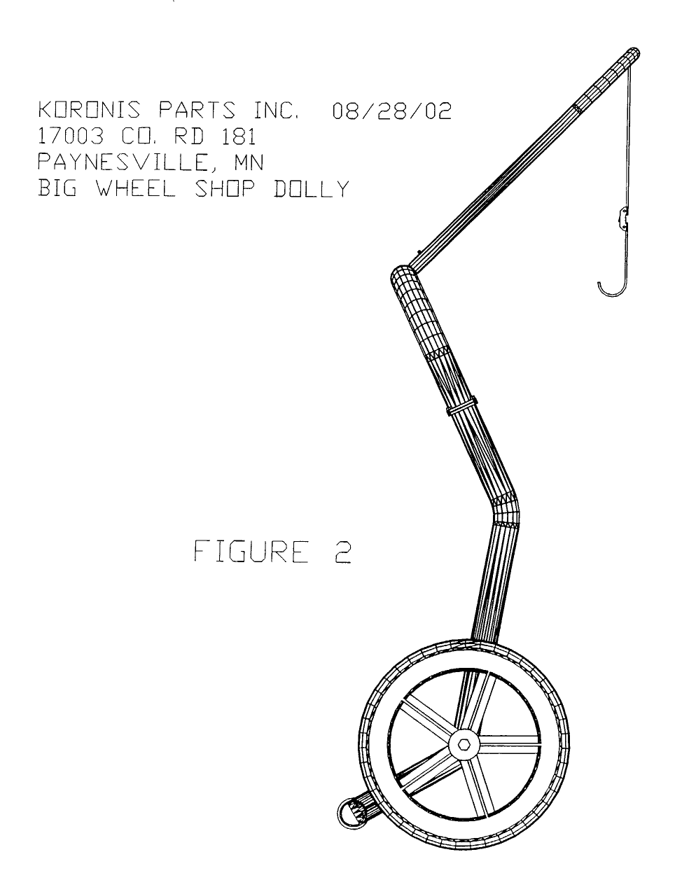

FIG. 3: This provides a top view of the Large wheel and provides a relationship to the complete dolly.

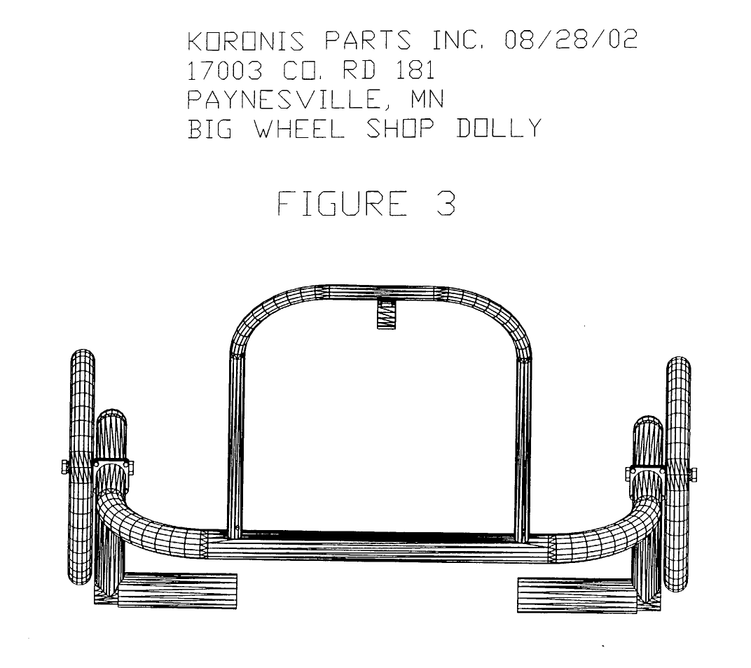

FIG. 4: This is a front view of the wheel alone with the tolerances of the width for the large wheel.

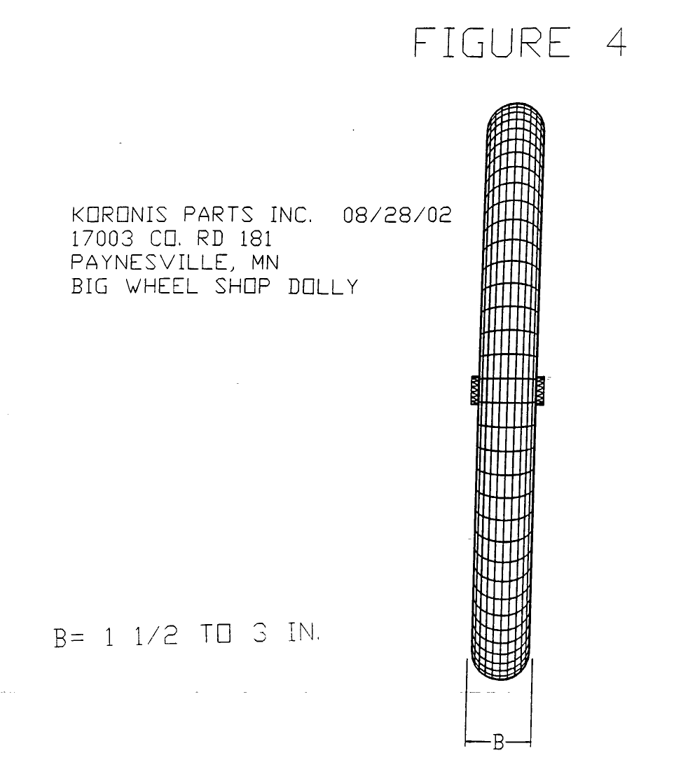

FIG. 5: This is side view of the large wheel alone with the tolerances of the diameter.

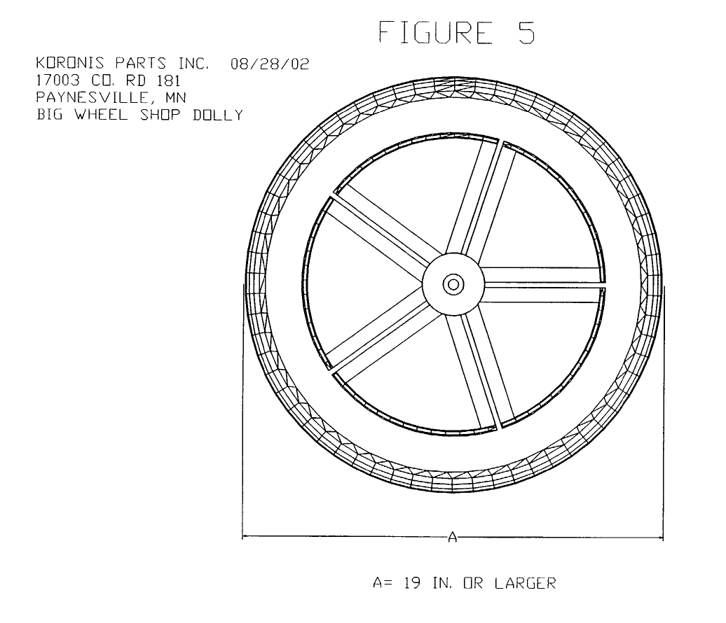

FIG. 6: This is an angled view of the complete invention assembled.

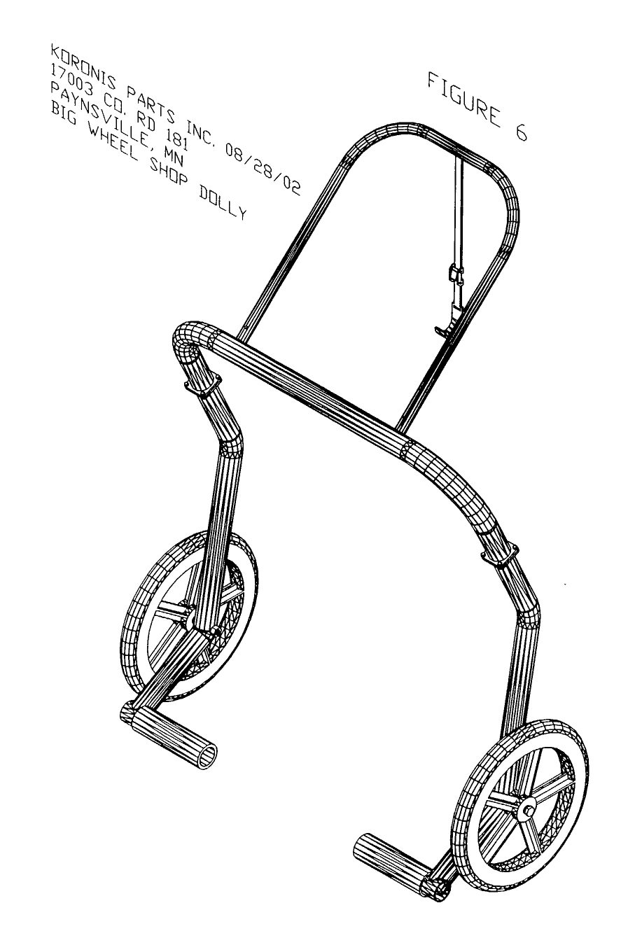

### DETAILED DESCRIPTION OF THE INVENTION

The disclosed invention has a noticeably larger wheel that existing snowmobile dollies. It is much easier to enter building and roll in various conditions of the surface. Because of the large wheel the conditions of a surface may vary without a noticeable ability to roll. Such as snow on the surface or wet surfaces. In addition, with the larger wheel the body can roll over curbs, within an entry, easily without assistance of another person or existing extreme force. This invention is the combination of commonly available items. Snowmobile Shop Dollies and 20 inch diameter wheels or larger with a width of 1.5 inches to 3 inches. The shop dollies commonly available in the snowmobile industry and the wheels commonly available in the bicycle industry.

1. What I claim as my invention is a 20 inch or more diameter and 1.5 inch to 3 inch width wheel on a snowmobile shop dolly.
